(19) United States
(12) Patent Application Publication
(10) Pub. No.: US 2025/0363537 A1
(43) Pub. Date: Nov. 27, 2025

(54) METHOD AND SYSTEM FOR PUBLISHING PRODUCTS ON MULTIPLE PLATFORMS

(71) Applicant: SHENZHEN MEIYUNJI NETWORK TECHNOLOGY CO., LTD, ShenZhen (CN)

(72) Inventors: Zhichao WANG, ShenZhen (CN); Huan LIU, ShenZhen (CN); Yixi LIANG, ShenZhen (CN); Weixian LI, ShenZhen (CN); Xihao HUANG, ShenZhen (CN)

(73) Assignee: SHENZHEN MEIYUNJI NETWORK TECHNOLOGY CO., LTD, ShenZhen (CN)

(21) Appl. No.: 19/191,230

(22) Filed: Apr. 28, 2025

(30) Foreign Application Priority Data
May 27, 2024 (CN) 202410659617.8

(51) Int. Cl. G06Q 30/0601; G06F 16/958

(52) U.S. Cl. CPC G06Q 30/0613; G06F 16/958; G06Q 30/0641

(57) ABSTRACT

A method and system for publishing products on multiple platforms. The method includes: determining, in response to a platform determination instruction, ports of e-commerce platforms corresponding to the platform determination instruction; obtaining initial product data in response to a first publishing instruction, and generating first publishing information based on the initial product data; identifying the initial product data based on a preset model to generate second publishing information; detecting a blank mandatory item related to product attributes in a publishing page of each of the e-commerce platforms, and setting a preset sequence option of the blank mandatory item as third publishing information; and sending the first publishing information, the second publishing information, and the third publishing information to the ports of the e-commerce platforms to publish a product corresponding to the initial product data on each of the e-commerce platforms.

### TECHNICAL FIELD

The present application relates to the technical field of computers, and in particular to a method for generating e-commerce package logistics information, a method for publishing products on multiple platforms, and systems thereof.

### BACKGROUND

With the rise of global e-commerce, international retail trade has developed rapidly, and a large number of domestic small and medium-sized e-commerce users have expanded their retail business to foreign markets, selling a large number of domestic goods to foreign markets through overseas e-commerce platforms. With the development of cross-border business, e-commerce enterprise resource planning (ERP) systems based on ERP software have gradually developed. E-commerce ERP systems can be deeply connected with e-commerce platforms, helping domestic small and medium-sized e-commerce users to manage their overseas stores uniformly, solving the obstacles brought by language differences, and enabling one operator to manage hundreds of e-commerce stores, significantly improving store operation efficiency.

E-commerce ERP systems access and control stores on e-commerce platforms through established rules, process dynamic data at various stages of store operations, and manage complex data while meeting the convenience needs of various types of users. Therefore, the functional modules of existing commercialized e-commerce ERP systems are still in the stage of gradual updating and improvement of functions. The functional algorithms and rules established by each software company when developing their own e-commerce ERP systems are also largely different, and new versions of each functional module will continue to be developed to accommodate more use cases as user needs change.

In actual e-commerce activities, for order processing scenarios where sellers need to handle self-shipment, sellers usually ship packages from their own warehouses to e-commerce platform warehouses in the order of store order placement, and then the e-commerce platform warehouses deliver the packages to buyers and generate the corresponding logistics track of the packages. In this order processing scenario, buyers cannot query the logistics track of the packages for a long time after placing the order, which can easily lead to some buyers losing trust in the seller or the e-commerce platform for delivery, thereby increasing the risk of buyers requesting or returning orders and causing losses to sellers.

In addition, in the product publishing stage, some e-commerce ERP systems have begun to have a one-click product publishing function, that is, users operate the e-commerce ERP system to obtain product data and simultaneously apply the product data to the publishing pages of multiple site stores of multiple e-commerce platforms, thereby achieving the purpose of one-click product publishing. However, in actual application, the e-commerce ERP system cannot accurately match the product publishing data to the mandatory items in the product publishing page, resulting in a high failure rate of the one-click product publishing function when used to publishing products on multiple platforms and multiple sites. It is usually only used to publishing products on the same platform and the same site store, which seriously affects the efficiency of e-commerce operations.

Other technical issues related to the present application are further described below. The above description is only used to assist the understanding of the technical solutions of the present application, and does not mean that all of the above contents are related arts.

### SUMMARY

The main purpose of the present application is to provide a method and a system for generating a package logistics track, which can generate the package delivery logistics track in advance for buyers to query before the package arrives at the warehouse of the e-commerce platform, thereby reducing the risk of buyers urging or returning orders due to logistics reasons, and reducing the system operation cost generated by the e-commerce platform for generating logistics tracks for multiple packages respectively. In addition, the present application also provides a method for publishing products on multiple platforms and system, which can improve the accuracy of filling product category information when publishing products in different platform and different site stores by e-commerce ERP system, and greatly improve the success rate of automatic publishing of products.

To achieve the above purpose, the present application provides a method and a system for generating a package logistics track, including:
step S1, obtaining order information of unshipped orders of a store, recording an order obtaining time t of the order information, and setting a group package benchmark time T;
step S2, determining an earliest time value to based on the order obtaining time t, and determining target orders whose order obtaining time t is within a preset time period Tn, the preset time period Tn is a time range from the earliest time value to to the earliest time value to +group package benchmark time T;
step S3, extracting delivery address information in the target orders, and classifying the target orders based on the delivery address information and preset delivery areas to generate combined orders;
step S4, generating corresponding group package data based on the combined orders, and performing logistics distribution in group packages after combining the packages of multiple target orders; and
step S5, calling a data interface of an e-commerce platform, and uploading the group package data to the e-commerce platform through the data interface, the group package data is used to generate a first logistics track for the group package between the seller's warehouse and the platform's warehouse on the e-commerce platform. The e-commerce platform can generate multiple second logistics track data based on the first logistics track data and the order information contained in the group package data. The multiple second logistics tracks respectively correspond to the packages of the multiple target orders. The second logistics tracks are used to display to buyer terminals respectively corresponding to the multiple target orders.

Other features and technical effects of the present application are described in the later part of the description. The idea for solving the technical problem and related product design solution of the present application are as follows.

The applicant found that the buyer cannot query the logistics track of the order package for a long time after placing an order. The reason is that the order package needs to be delivered from the seller's warehouse to the e-commerce platform warehouse before it is sent to the buyer's address by the e-commerce platform. Since the e-commerce platform connects with a large number of seller users and processes a large number of orders, it is difficult for the e-commerce platform to bear the system operation pressure caused by generating logistics tracks for all packages involved in the orders. Therefore, the e-commerce platform can only generate the logistics track of the package for the buyer to query after the package arrives at the e-commerce platform warehouse. Therefore, the buyer cannot query the package logistics track (second logistics track) before the order package arrives at the e-commerce platform warehouse.

The applicant also found that in order to ensure the transportation safety of the group package (combined package) containing multiple order packages before it reaches the e-commerce platform warehouse, the e-commerce platform will generate a logistics track (first logistics track) corresponding to the group package. On this basis, within the group package benchmark time T, multiple order packages shipped to the same e-commerce platform warehouse are combined to obtain the group package, and the data interface of the e-commerce platform (which can transmit group package data) is called to upload the corresponding group package data to the e-commerce platform through the data interface. The e-commerce platform sets the logistics track (first logistics track) of the group package as the logistics track (second logistics track) corresponding to each of the multiple order packages, respectively, so that the buyer can query the logistics track (second logistics track) of the package in time before the package arrives at the e-commerce platform warehouse, so that buyers can obtain the logistics information of the package in advance by putting the package online in advance. Moreover, limiting the group package time to the group package benchmark time T can also effectively reduce the risk of delivery delay caused by the group package process to orders placed earlier, and ensure that order packages can be shipped and delivered in time.

In addition, the applicant has also found that after the e-commerce platform generates the first logistics track for the group package, it sets the first logistics track as the second logistics track of multiple order packages corresponding to the group package. At this time, the system only needs to generate one first logistics track to meet the buyer information query demand corresponding to multiple orders. There is no need to generate multiple second logistics tracks corresponding to multiple order packages, which greatly shortens the online time of the order package (the online time refers to the first logistics track time that can be queried). Moreover, when the seller ships the multiple order packages to the e-commerce platform warehouse in group packages, the logistics costs of the seller can be reduced, and the operation costs of the e-commerce platform warehouse for collecting the packages can also be reduced.

The method for generating the package logistics track can generate a corresponding logistics track for the order package before it arrives at the e-commerce platform warehouse, so that the buyer can query the logistics track of the order package in advance after placing an order, increase the content of the logistics track that the buyer can query, meet the buyer's information query demand for the order package, improve the buyer's trust in product delivery, and reduce the risk of the buyer's urging or returning the order. In addition, by setting the first logistics track of the group package as the second logistics track of the multiple order packages, the system operation cost of generating the order package logistics track is reduced. At the same time, shipping multiple order packages in group packages can reduce the seller's logistics costs, as well as reduce the operation costs of the e-commerce platform warehouse for collecting the packages, thereby improving the operation efficiency of e-commerce activities.

Further, the present application also provides a method and a system for publishing products on multiple platforms, applied to the product module of an e-commerce ERP system, and the method includes:
step M1, determining, in response to a platform determination instruction, ports of the e-commerce platforms corresponding to the platform determination instruction;
step M2, obtaining initial product data in response to a first publishing instruction, generating first publishing information based on the initial product data, the first publishing information includes a publishing store, product inventory, product weight, and logistics mode, and the first publishing information is mandatory information that needs to be filled in when publishing products on each e-commerce platform;
step M3, identifying the initial product data based on a preset model to generate second publishing information, the second publishing information includes product category information, the preset model includes a plurality of fully connected layers corresponding to product attribute categories of the e-commerce platform, the plurality of fully connected layers are respectively used to output a plurality of classification prediction values corresponding to the product attribute categories, and the product category information is generated based on the classification prediction values;
step M4, detecting a blank mandatory item related to the product attribute in a publishing page of each e-commerce platform, and setting a preset sequence option of the blank mandatory item as third publishing information; and
step M5, sending the first publishing information, the second publishing information, and the third publishing information to the ports of the e-commerce platforms, to publish the product corresponding to the initial product data on the e-commerce platforms.

Other features and technical effects of the present application are described in the later part of the description. The ideas for solving the technical problem and related product design solutions of the present application are as follows.

The applicant found that the failure rate of the one-click product publishing function of the e-commerce ERP system is very high when publishing products on multiple platforms and multiple sites. The reason is that there are differences in the mandatory items on the product publishing pages of each e-commerce platform and each site. When the same product data is applied to multiple product publishing pages, the product data cannot accurately match the mandatory items on different product publishing pages. When the mandatory information of the product category on the product publishing page is filled in incorrectly, or there are specific mandatory items on the product publishing page of some e-commerce platforms, and the product data does not contain relevant information so that the specific mandatory items are empty, the e-commerce platform will determine that the product publishing information is filled in incorrectly, resulting in the failure of the product to be published on the e-commerce platform.

On this basis, the applicant found that among the mandatory items that differ on each product publishing page, the mandatory item of the product category has the greatest impact on the success rate of product publishing. By using a pre-trained deep model corresponding to each product publishing page to identify the product data and generate corresponding product category information, and filling the product category information into the mandatory item of the product category on the product publishing page, the accuracy of information filling in the mandatory item of the product category can be greatly improved, thereby improving the success rate of automatic product publishing.

The aforementioned pre-trained deep model has multiple fully connected layers, and the number of fully connected layers corresponds to the product attribute categories of the e-commerce platform. During the training process, the deep model outputs prediction values corresponding to multiple product attribute categories based on the product data, which can improve the recognition ability of the deep model for product categories, thereby improving the accuracy of the product category information generated by the deep model in actual application.

Moreover, the applicant also found that the publishing information required for the mandatory item of each product publishing is specifically classified into general information, important information, and specific mandatory items for processing, which can improve the product publishing efficiency of the e-commerce ERP system on the basis of improving the success rate of product publishing.

In an embodiment, for general information in the mandatory items of the product publishing that is easy to identify, such as publishing store, product inventory, product weight, logistics mode, it is usually required to be filled in when publishing products on various e-commerce platforms, and the recognition accuracy is relatively high. Therefore, local processing is performed based on the e-commerce ERP system, and there is no need to call the deep model.

For important information in the mandatory items for product publishing that is difficult to identify and has a greater impact on the success rate of publishing, such as product category information, a deep model is called to process and generate. Since the deep model only processes product category information, the training time of the deep model and the feedback time required by the deep model in actual application can be greatly reduced.

For specific mandatory items on the product publishing page, such as the product brand as a mandatory item on the product publishing page of some e-commerce platforms, the relevant information of this specific mandatory item will hardly exist in the product data collected by the e-commerce ERP system, and has no obvious impact on product publishing or store operation. However, if this specific mandatory item is blank, the product publishing will fail. Therefore, after the e-commerce ERP system performs regular information filling and deep model identification generation for the mandatory items on the product publishing page, if it is detected that there are mandatory items in a blank state on the product publishing page, a preset order option, such as the default first item, is automatically selected for the mandatory item as the publishing information of the mandatory item in the blank state.

In this way, the method for publishing products on multiple platforms proposed in the present application, after obtaining the initial product data corresponding to product publishing, determines the ports of each e-commerce platform corresponding to product publishing according to the preset publishing instruction triggered by the user, and then performs classification processing on the mandatory items on the product publishing page, the product category information is generated by deep model identification, thereby improving the accuracy of filling in the product category information on the product publishing page, and thus greatly improving the success rate of automatic product publishing; and significantly reducing the system operation cost generated when the e-commerce ERP system performs automatic product publishing, thereby improving the efficiency of automatic product publishing.

The present application also provides a system, which is an e-commerce ERP system or an e-commerce platform system, and the system can execute the operation instructions of the method steps of the present application.

The present application also provides a server, which includes a memory and a processor. The system in the present application is stored in the memory, and the processor can execute the operation instructions of the method steps of the present application.

The present application also provides a computer device, which includes a memory and a processor. The system in the present application is stored in the memory, and the processor can execute the operation instructions of the method steps of the present application.

Referring to FIG. 1, the e-commerce ERP system of the present application includes one or more of the following functional modules: a product module, a sales module, a procurement module, a logistics module, a warehouse module, a financial module, an advertising module, a customer service module, a tool module, a permission management module, a data analysis module, etc. Each functional module can be integrated with each other, or can exist independently, or one functional module can be a sub-module of another functional module. Each functional module of the present application can also be set on other e-commerce management systems (such as e-commerce platforms) for managing shops of the present e-commerce management system or other e-commerce management systems. The user of the ERP system of the present application can also be referred to as a shop manager, a seller, an operator, an operating personnel, etc., and its identity is not strictly limited unless specifically stated.

### BRIEF DESCRIPTION OF THE DRAWINGS

The accompanying drawings are used to provide a further understanding of the present application and do not constitute a limitation to the present application. The contents shown in the accompanying drawings can be real data of the embodiments and belong to the scope of the present application.

FIG. 1 is a schematic diagram of functional modules of an e-commerce ERP system according to an embodiment of the present application.

FIG. 2 is a schematic diagram of the interaction between the e-commerce ERP system and the e-commerce platform regarding the process of generating package logistics information according to an embodiment of the present application.

FIG. 3 is a flowchart of a method for generating e-commerce package logistics information according to an embodiment of the present application.

FIG. 4 is a schematic diagram of the interaction between the e-commerce ERP system and the e-commerce platform regarding the product publishing process according to an embodiment of the present application.

FIG. 5 is a flowchart of a method for publishing products on multiple platforms according to an embodiment of the present application.

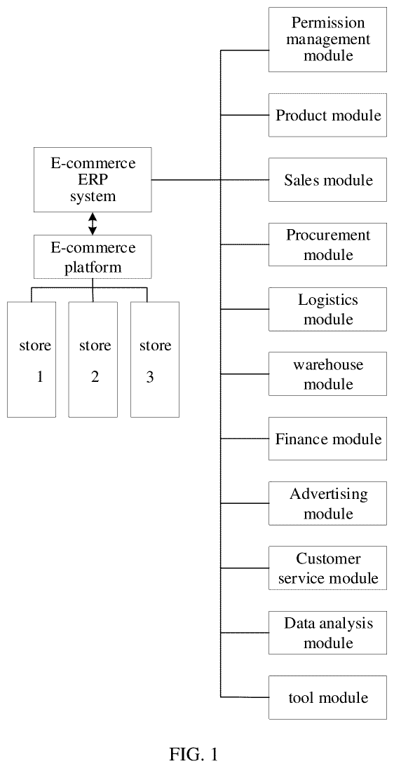

### DETAILED DESCRIPTION OF THE EMBODIMENTS

In order to make the purpose, technical solutions and advantages of the present application clearer, the embodiments of the present application will be further described in detail below with reference to the accompanying drawings. It should be understood that the specific embodiments described herein are only used to explain the present application and not to limit the present application.

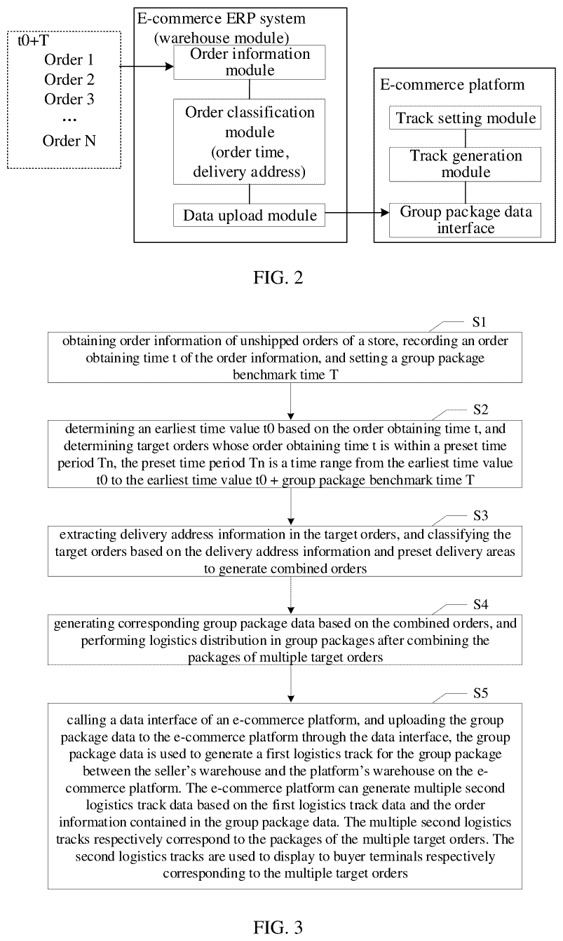

FIG. 2 shows a schematic diagram of the interaction between an e-commerce ERP system and an e-commerce platform in the process of generating package logistics information according to an embodiment of the present application. As shown in FIG. 2, the e-commerce ERP system manages order information of each store based on an order information module, classifies and combines order information according to order time and delivery address through an order classification module, generates corresponding group package data, and uploads the group package data to the e-commerce platform through a data upload module. The e-commerce platform obtains the group package data through a group package data interface, generates a first logistics track corresponding to the transportation of the group package from the seller's warehouse to the platform warehouse through a track generation module according to the group package data, and sets the first logistics track of the group package as a second logistics track corresponding to the group package containing multiple packages through a track setting module, so as to meet the information query needs of the buyer terminals of the orders corresponding to the multiple packages.

FIG. 3 shows a method for generating e-commerce package logistics information according to an embodiment of the present application, which mainly includes the following steps S1 to S5.

Step S1, obtaining order information of unshipped orders of a store, recording an order obtaining time t of the order information, and setting a group package benchmark time T.

Step S2, determining an earliest time value to based on the order obtaining time t, and determining target orders whose order obtaining time t is within a preset time period Tn, the preset time period Tn is a time range from the earliest time value to to the earliest time value to +group package benchmark time T.

Step S3, extracting delivery address information in the target orders, and classifying the target orders based on the delivery address information and preset delivery areas to generate combined orders.

Step S4, generating corresponding group package data based on the combined orders, and performing logistics distribution in group packages after combining the packages of multiple target orders.

Step S5, calling a data interface of an e-commerce platform, and uploading the group package data to the e-commerce platform through the data interface, the group package data is used to generate a first logistics track for the group package between the seller's warehouse and the platform's warehouse on the e-commerce platform. The e-commerce platform can generate multiple second logistics track data based on the first logistics track data and the order information contained in the group package data. The multiple second logistics tracks respectively correspond to the packages of the multiple target orders. The second logistics tracks are used to display to buyer terminals respectively corresponding to the multiple target orders.

In this way, the method for generating package logistics track provided in the present application can generate a corresponding logistics track for the order package before it arrives at the warehouse of the e-commerce platform, so that buyers can query the logistics track of the order package in advance after placing an order, increasing the content of the logistics track that buyers can query, meeting the buyers' information query needs for the order package, improving buyers' trust in product distribution, and reducing the risk of buyers' order chasing or order cancellation. In addition, by setting the first logistics track of the group package as the second logistics track of the multiple order packages, the system operation cost of generating the logistics track of the order package is reduced. At the same time, shipping multiple order packages in group packages can reduce the sellers' logistics costs, and reduce the operation costs of the e-commerce platform warehouse for collecting packages, thereby improving the operation efficiency of e-commerce activities.

Each method step in the method for generating e-commerce package logistics information is described in detail below.

Step S1, obtaining the order information of unshipped orders of the store, recording the order obtaining time t of the order information, and setting a group package benchmark time T.

In an embodiment, the e-commerce ERP system obtains the order information from authorized stores on the e-commerce platform, selecting unshipped orders, recording the order obtaining time, and setting the group package benchmark time T according to user instructions.

Step S2, determining the earliest time value to based on the order obtaining time t, and determining target orders whose order obtaining time t is within a preset time period Tn, where the preset time period Tn is the time range from the earliest time value t0 to the earliest time value to +group package benchmark time T.

In an embodiment, the e-commerce ERP system determines the earliest time value to of unshipped orders, and determines unshipped orders within the time range from the earliest time value t0 to preset time period Tn, i.e., the earliest time value t0+the group package benchmark time T, as target orders. That is, the e-commerce ERP system performs package combination once within the time period of each group package benchmark time T.

It should be noted that in related embodiments, other methods can be used to obtain target orders within a certain time period, which are not limited here.

Step S3, extracting the delivery address information in the target orders, and classifying the target orders based on the delivery address information and preset delivery areas to generate combined orders.

In an embodiment, when the delivery addresses of the orders are in the same or adjacent delivery areas, the order packages are usually delivered to the same e-commerce platform warehouse, and on this basis, the orders delivered to the same e-commerce platform warehouse are divided into the same category, and then the combined order is generated.

Step S4, generating corresponding group package data based on the combined order, and performing logistics distribution in group packages after the packages of the multiple target orders are combined.

In an embodiment, the e-commerce ERP system generates group package data corresponding to the combined order to upload the group package data to the e-commerce platform, and after the order packages corresponding to the combined order are packed in the warehouse, logistics distribution is uniformly performed to the e-commerce platform warehouse in group packages.

Step S5, calling a data interface of the e-commerce platform, and uploading the group package data to the e-commerce platform through the data interface. The group package data is used to generate a first logistics track of the group package between the seller warehouse and the platform warehouse on the e-commerce platform, and the e-commerce platform can generate multiple second logistics track data based on the first logistics track data and the order information contained in the group package data. The multiple second logistics tracks respectively correspond to the packages of the multiple target orders, and the second logistics track is used to be displayed to the buyer terminal corresponding to the multiple target orders respectively.

In an embodiment, after generating the group package data, the e-commerce ERP system calls a preset data interface of the e-commerce platform for uploading the group package data, and uploads the group package data to the e-commerce platform through the preset data interface. The group package data includes a corresponding waybill number provided by a third party institution and a proactive collection instruction. When the package combination is transported from the seller warehouse to the e-commerce platform by the third party institution, the e-commerce ERP system uploads the waybill number to the e-commerce platform, and the e-commerce platform queries the location information of the package combination before it arrives at the e-commerce platform warehouse according to the waybill number, and generates a corresponding first logistics track according to the location information. Alternatively, when the e-commerce platform is responsible for picking up the packages from the seller's warehouse, the e-commerce ERP system sends a proactive collection instruction to the e-commerce platform, the e-commerce platform actively picks up and transports the group package, and generates a first logistics track of the group package according to the location information of the group package in the transportation process. After the e-commerce platform generates the first logistics track, the e-commerce platform sets the first logistics track as the second logistics track corresponding to the order information contained in the group package data, and displays the second logistics track to the buyer terminals corresponding to the above target orders based on the e-commerce platform.

Further, in an embodiment, the setting the group package benchmark time of step S1 includes the following steps S1.11 and S1.12.

Step S1.11, obtaining historical order records of the store, and determining an order transaction frequency v of each preset time period Tn according to the historical order records.

Step S1.12, setting the group package benchmark time T in each preset time period Tn according to the order transaction frequency v includes: if the order transaction frequency v1 of the preset time period Tn1 is greater than the order transaction frequency v2 of the preset time period Tn2, the group package benchmark time T1 of the preset time period Tn1 is less than the group package benchmark time T2 of the preset time period Tn2.

In an embodiment, during the group package process, a relatively shorter group package benchmark time is set during the time period with a higher order transaction frequency, and a relatively longer group package benchmark time is set during the time period with a lower order transaction frequency.

Because the applicant found that if the same group package benchmark time is used for time periods with different order transaction frequencies, in the time periods with higher order transaction frequencies, due to long time for group package, it may lead to too many packages being packaged at one time, which is not conducive to logistics distribution and delays the package delivery time, and causes great computing pressure on the system. While in the time periods with lower order transaction frequencies, due to the short time for group package, it may lead to too few packages being packaged at one time, which increases the logistics distribution costs. Therefore, the order transaction frequency in each time period is determined according to the historical order records of the store, and then the length of the group package benchmark time is adjusted according to the order transaction frequency, so as to balance multiple parameters involved in the group package process, such as the number of group packages, the package delivery time and the logistics distribution cost, and achieve higher group package delivery efficiency.

Further, based on the above embodiment, step S1.12 of setting the group package benchmark time T in each preset time period TN according to the order transaction frequency v includes the following steps S1.121 and S1.122.

Step S1.121, setting a proportional parameter q that represents the proportional relationship between the order transaction frequency v and the group package benchmark time T.

Step S1.122, setting the group package benchmark time T according to the order transaction frequency v and the proportional parameter q, where T=qv.

In an embodiment, based on the proportional parameter q, the length of the group package benchmark time T is adjusted accordingly according to the change in the number of order transactions in a unit time period. For example, when the number of order transactions increases by 20 within a preset time period, the group package benchmark time within the preset time period is shortened by 5 minutes, thereby automatically setting the group package benchmark time for each preset time period based on the proportional parameter q, meeting the user's personalized needs for adjusting the group package benchmark time, and improving the convenience of operation.

In an embodiment, since there is not necessarily a linear correspondence between the order transaction frequency v and the group package benchmark time T, the historical order records of the store are used as samples to train a deep learning model, and limit parameters such as the number of orders corresponding to the group package and the logistics distribution cost are set for the deep learning model. Then, the functional relationship Q between the order transaction frequency v and the group package benchmark time T can be determined based on the deep learning model, where T=Q (v). Therefore, a more accurate group package benchmark time can be set based on the deep learning model. On the basis of meeting the basic needs of users to query the package logistics trajectory, multiple parameters involved in the group package process, such as the group package quantity, package delivery time, and logistics distribution cost, can reach an optimal balance, thereby further improving the efficiency of group package in executing logistics distribution.

Further, in an embodiment, the setting the group package benchmark time in step S1 includes the following step S1.13.

Step S1.13, monitoring the order transaction status of the store, and in response to that the number of undelivered orders s reaches a preset threshold n, setting the monitoring time between the earliest time value t0 and the nth order obtaining time tn as the group package benchmark time T.

In an embodiment, the e-commerce ERP system continuously monitors the order transactions of the store, starts counting from the number of undelivered orders as 0, and when the number of undelivered orders of the store reaches a preset threshold, such as the preset threshold of 20, the 20 undelivered orders are set as target orders, and then the classification and packaging are performed for the target orders. In this way, this embodiment determines the time to perform the package combination action based on the order data, which can further improve the flexibility of the package combination process and improve the efficiency of package delivery.

Further, in an embodiment, after step S2, the method further includes the following step S6.1.

Step S6.1, if the number of the target order does not reach the preset number of orders within the group package benchmark time T, in response to the order urging instruction, the package of the target order corresponding to the order urging instruction is shipped separately.

In an embodiment, the group package condition includes that the target order reaches the preset number of orders, such as the preset number of orders is 20. When the e-commerce ERP system detects that the number of target orders does not reach 20 within the group package benchmark time, and the e-commerce ERP system receives an order urging shipment instruction for a certain target order, the package of the target order corresponding to the order urging shipment instruction is shipped separately without the package combination action, thereby advancing the shipment time of the package of the urged target order to meet the buyer's demand for the speed of order package delivery.

Further, based on the above embodiment, after step S6, the method further includes the following steps S6.2 to S6.4.

Step S6.2, in response to a reminder instruction for the target order corresponding to separate shipment, generating the first logistics track of the package of the target order from the seller's warehouse to the platform's warehouse;

Step S6.3, displaying the first logistics track data to the buyer terminal corresponding to the target order based on the customer service system of the e-commerce platform; or

Step S6.4, sending the first logistics track data to the buyer terminal corresponding to the target order.

In an embodiment, for order packages that are shipped separately due to order reminders, the seller transports the order packages from its own warehouse to the e-commerce platform warehouse through a third-party agency. At this time, the order packages cannot generate the corresponding logistics track by uploading the group package data to the e-commerce platform. On this basis, in order to meet the buyer's information query needs and reduce the risk of repeated order reminders or order returns, the seller obtains the logistics track data of the order package from a third-party agency, and uploads the logistics track data to the e-commerce platform store through the e-commerce ERP system, and then displays the logistics track data to the buyer's terminal corresponding to the order through the customer service system of the e-commerce platform store, or sends the logistics track data to the buyer's terminal through online forms such as email.

Further, in an embodiment, the obtaining information about unshipped orders from the store in step S1 includes the following steps S1.21 to S1.24.

Step S1.21, obtaining the warehouse information of each store;

Step S1.22, classifying each store based on the warehouse information to generate bound stores, where the bound stores include a main store and multiple sub-stores;

Step S1.23, uploading information about the bound stores to the supply chain collaboration system of the e-commerce platform, where the information about the bound stores is used to synchronize the order data of the multiple sub-stores to the main store in the supply chain collaboration system; and

Step S1.24, obtaining information about the unshipped order of the main store.

In an embodiment, some e-commerce platforms do not allow cross-store order packages to be packaged and shipped, because in the presence of store management authority, the mixed processing of order data across stores may cause greater operating pressure on the system, thereby affecting the normal operation of the system. On this basis, the present application obtains store warehouse information, classifies stores using the same warehouse to generate bound stores, determines a main store and multiple sub-stores in the bound stores, and uploads information about the bound stores to the supply chain collaboration system of the e-commerce platform. The supply chain collaboration system synchronizes the order data of multiple sub-stores to the main store to complete the store binding operation. At this time, the order data of the bound stores are all regarded as coming from the main store, thereby avoiding interference with the existing store management permissions and reducing the risk of affecting the system operation.

Further, in an embodiment, classifying the target orders based on the delivery address information and the preset delivery area to generate a combined order in step S3 includes the following steps S3.1 to S3.3.

Step S3.1, classifying the target orders based on the type of e-commerce platform to which each store belongs to generate first combined orders;

Step S3.2, classifying the first combined orders based on the correspondence between the delivery address information and the preset delivery area to generate second combined orders; and

Step S3.3, classifying the second combined orders based on logistics pickup methods to generate the combined orders.

In an embodiment, for multiple targeted orders whose order obtaining time is within the group package benchmark time, the target orders that come from the same e-commerce platform, have the same delivery address information corresponding to the preset delivery area, and use the same logistics pickup method, such as transportation by a third-party agency, are divided into the same category, and then a combined order is generated. At this time, the logistics operations of transporting target orders in the same category from the seller's warehouse to the e-commerce platform warehouse are highly similar, thereby reducing logistics costs.

Furthermore, in an embodiment, before the above step S5, the method further includes the following steps S7.1 and S7.2.

Step S7.1, obtaining the preset order data corresponding to the unpacked preset package; and

Step S7.2, based on the delivery address information of the preset order data, writing the preset order data into the corresponding group package data to generate virtual packaging data, the virtual packaging data is used to generate the first logistics track data corresponding to the preset order data.

In an embodiment, in actual e-commerce activities, some buyers have an urgent need to query the logistics track of order packages, while the packages corresponding to the orders are in an unpacked and shipped state. At this time, the e-commerce ERP system writes the order data into the packaging data that completes the packaging action to generate virtual packaging data, then uploads the virtual packaging data to the e-commerce platform, and performs logistics distribution on the packaging. The e-commerce platform generates the first logistics track corresponding to the packaging according to the virtual packaging data, and sets the first logistics track to the second logistics track of the packages corresponding to each target order contained in the virtual package data. The orders whose packages have not been actually shipped also have the second logistics track that can be queried. After the e-commerce platform has counted the packages, it will issue an instruction to the seller to resend the packages, and the seller has sufficient time to pack and resend the order packages that have not been actually shipped in the virtual package data, which can avoid the order packages waiting for the next round of packaging and shipping, accelerate the shipping time, and meet the buyer's urgent need to query the logistics track of the order packages, reducing the risk of repeated order reminders or order returns.

In an embodiment, the present application also provides a method for publishing products on multiple platforms.

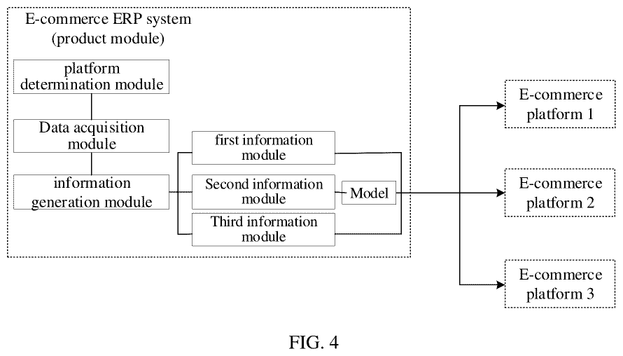

FIG. 4 shows an interactive schematic diagram of the product publishing process between the e-commerce ERP system and the e-commerce platform according to an embodiment of the present application. As shown in FIG. 4, the e-commerce ERP system responds to the platform determination instruction triggered by the user, and determines the e-commerce platform ports for publishing products based on the platform determination module. Then, in response to the first publishing instruction triggered by the user, the initial product data is obtained based on the data acquisition module, and the first publishing information is generated according to the initial product data based on the first information module, such as the publishing store, product inventory, product weight, and logistics method. Then, the deep model corresponding to the e-commerce platform is called based on the second information module, and the deep model generates the second publishing information based on the initial product data, that is, the product category information. In addition, based on the third information module, it is detected whether there are blank mandatory items related to the product attributes on the product publishing page, and a preset option is selected for the blank mandatory items as the third publishing information. Finally, the first publishing information, the second publishing information and the third publishing information are sent to each e-commerce platform port respectively to realize the information filling operation for the product publishing page of each e-commerce platform, thereby publishing the product to each e-commerce platform.

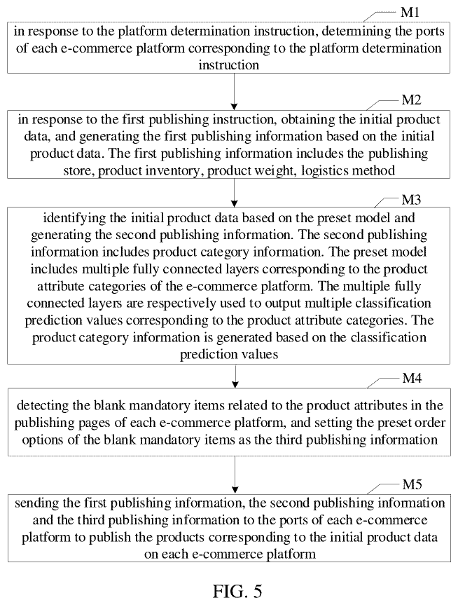

FIG. 5 shows a method for publishing products on multiple platforms according to an embodiment of the present application, which mainly includes the following steps M1 to M5.

Step M1, in response to a platform determination instruction, determining each e-commerce platform port corresponding to the platform determination instruction.

Step M2, in response to a first publishing instruction, obtaining initial product data, and generating first publishing information based on the initial product data, the first publishing information includes publishing store, product inventory, product weight, and logistics method.

Step M3, identifying the initial product data based on the preset model and generating the second publishing information. The second publishing information includes product category information. The preset model includes multiple fully connected layers corresponding to the product attribute categories of the e-commerce platform. The multiple fully connected layers are respectively used to output multiple classification prediction values corresponding to the product attribute categories, and the product category information is generated based on the classification prediction values.

Step M4, detecting the blank mandatory items related to the product attributes in the publishing pages of each e-commerce platform, and setting the preset order options of the blank mandatory items as the third publishing information.

Step M5, sending the first publishing information, the second publishing information, and the third publishing information to the ports of each e-commerce platform to publish the product corresponding to the initial product data on each e-commerce platform.

In this way, the method for publishing products on multiple platforms proposed in the present application determines the ports of each e-commerce platform corresponding to the product publishing according to the preset publishing instruction triggered by the user after obtaining the initial product data corresponding to the product publishing, and then performs classification processing on the mandatory items on the product publishing page. The product category information is identified and generated by the deep model, which improves the accuracy of filling in the product category information on the product publishing page, thereby greatly improving the success rate of automatic product publishing, and significantly reducing the system computing cost generated when the e-commerce ERP system executes the automatic publishing of products, and improving the efficiency of automatic publishing of products.

The following is a detailed description of each method step in the method for publishing products on multiple platforms.

Step M1, in response to the platform determination instruction, determining the ports of each e-commerce platform corresponding to the platform determination instruction.

In an embodiment, the user triggers the platform determination instruction to the e-commerce ERP system, and the e-commerce ERP system determines the ports of the e-commerce platform for publishing products.

Step M2, in response to the first publishing instruction, obtaining the initial product data, and generating the first publishing information based on the initial product data. The first publishing information includes the publishing store, product inventory, product weight, logistics method, etc.

In an embodiment, the e-commerce ERP system responds to the first publishing instruction triggered by the user and obtains the pre-stored initial product data. The initial product data is data recording the information required for the product to be published on the e-commerce platform, including product pictures, product videos, product attribute information, etc. The e-commerce ERP system identifies the initial product data and generates the first publishing information. The first publishing information is general information that is easy to identify, such as the publishing store, product inventory, product weight, logistics method, etc, which is mandatory information that must be filled in when each e-commerce platform publishes a product.

Step M3, identifying the initial product data based on the preset model and generating the second publishing information. The second publishing information includes product category information. The preset model includes multiple fully connected layers corresponding to the product attribute categories of the e-commerce platform. The multiple fully connected layers are respectively used to output multiple classification prediction values corresponding to the product attribute categories. The product category information is generated based on the classification prediction values.

In an embodiment, the deep model corresponding to the e-commerce platform is called. The deep model generates the second publishing information based on the initial product data. The second publishing information is important information that is difficult to identify in the mandatory items for product publishing and has a greater impact on the publishing success rate, such as product category information.

When publishing products on e-commerce platforms, incorrect information in the mandatory items of the product category on the product publishing page is the main reason for product publishing failure. The incorrect information in the product category may result from errors in the recognition of the initial product data by the e-commerce ERP system when performing the automatic product publishing function, or it may be due to the inconsistency of the product category rules of each e-commerce platform, causing the e-commerce ERP system to fail to correctly match the product category options in the mandatory items of the product category according to the initial product data. This results in the e-commerce platform's incorrect determination of product classification. Therefore, in the present application, the e-commerce ERP system calls the deep model corresponding to the e-commerce platform. The deep model is trained based on the data samples and product category rules of the e-commerce platform. The initial product data is identified by the deep model to generate product category information, and the product category information is set as the second publishing information.

It should be noted that the above-mentioned deep model is different from the AI model commonly used by e-commerce platforms, or AI intelligent models such as GPT, in the following ways: conventional AI models are used to handle various types of problems, and output corresponding responses after analyzing specific problems; the deep model of the present application corresponds to the e-commerce platform, is trained based on the data samples and product category rules of the e-commerce platform, and is only used to generate product category information. It can be understood that since the deep model only processes product category information, a single type of data sample is used in the process of training the model, the model training can be completed in a relatively short time, and in actual applications, it can quickly provide product category information to the e-commerce ERP system. That is, the data sample acquisition difficulty of the deep model of the present application is relatively low, the required training time can be greatly reduced, the operating efficiency in actual application is relatively high, and the output product category information has a high accuracy.

Step M4, detecting the blank mandatory items related to the product attributes in the publishing pages of each e-commerce platform, and setting the preset order options of the blank mandatory items as the third publishing information.

In an embodiment, the product publishing page of some e-commerce platforms has specific mandatory items, such as the product brand as a mandatory item. This specific mandatory item is rarely used as a mandatory item for publishing products on other e-commerce platforms, is almost never exists in the product data collected by the e-commerce ERP system, and has no significant impact on product publishing or store operation. However, if this specific mandatory item is blank, it will cause the product publishing to fail.

Therefore, after the e-commerce ERP system performs general information filling and deep model recognition generation for the mandatory items on the product publishing page, if it is detected that there is a mandatory item in a blank state on the product publishing page, the preset order option is automatically selected for the mandatory item, such as the default first item, as the third publishing information of the blank mandatory item.

Step M5, sending the first publishing information, the second publishing information and the third publishing information to the ports of each e-commerce platform to publish the products corresponding to the initial product data on each e-commerce platform.

In an embodiment, the e-commerce ERP system sends the first publishing information, the second publishing information and the third publishing information to the ports of each e-commerce platform to complete the information filling operation on the product publishing page of each e-commerce platform, thereby publishing the products on each e-commerce platform.

Further, in an embodiment, the method further includes the following steps S6.1 and S6.2.

Step M6.1, obtaining the historical publishing data corresponding to the products of each e-commerce platform.

Step M6.2, training the preset model corresponding to each e-commerce platform based on the historical publishing data.

In an embodiment, each e-commerce platform has differences in the product category name and product category level. For example, the same product may be classified into different product categories when it is published on different e-commerce platforms. In addition, the product category levels corresponding to the products when they are classified are different, such as product A corresponds to the third-level product category, product B corresponds to the second-level product category, and product C corresponds to the fourth-level product category.

In this embodiment, the e-commerce ERP obtains historical publishing data that can successfully publishing products on each e-commerce platform, sets model parameters based on the product category rules of the e-commerce platform, and uses the historical publishing data as a data sample to train a deep model for generating product category information corresponding to each e-commerce platform.

Further, based on the above embodiment, step M6.2 includes the following steps M6.21 to M6.24.

Step M6.21, determining the data source identifier corresponding to the historical publishing data.

Step M6.22, classifying the historical publishing data into first publishing data and second publishing data according to the data source identifier, the first publishing data is the historical publishing data that has not been modified by the user, and the second publishing data is the historical publishing data that has been modified by the user.

Step M6.23, training the preset models corresponding to each of the e-commerce platforms based on the first publishing data.

Step M6.24, verifying the accuracy of the classification prediction value output by the preset model based on the second publishing data.

In an embodiment, some e-commerce platforms have a product classification function, which can recommend a product classification interface based on the product data uploaded by the user when publishing the product, so as to help the user to publish the product with one click. In this embodiment, the historical publishing data corresponding to the product classification interface recommended by the e-commerce platform is used as the first publishing data, and the product category information set or modified by the user is used as the second publishing data. The first publishing data is greater in data volume than the second publishing data, and the first publishing data is lower in accuracy than the second publishing data. In this embodiment, the deep model is trained based on the first publishing data, which can meet the number of training samples required for model training, and the training samples do not need to be manually labeled, the difficulty of data acquisition is low, and the training cost is reduced. On this basis, the accuracy of the product category information output by the deep model is verified based on the second publishing data, which can better verify the maturity of the deep model.

Further, based on the above embodiment, step M6.23 includes the following steps M6.231 and M6.232.

Step M6.231, inputting the first publishing data into the basic model to enable the basic model to recognize the first publishing data, and outputting multiple training classification prediction values corresponding to the product attribute categories of the e-commerce platform based on the fully connected layer.

Step M6.232, adjusting the parameters of the basic model based on the multiple training classification prediction values.

In an embodiment, the first publishing data, which has not been modified by the user and corresponds to the product category interface recommended by the e-commerce platform, is input into the basic model for training. After the basic model recognizes the first publishing data, it outputs multiple training classification prediction values corresponding to the product attribute categories based on each connection layer. For example, product A has three levels of product categories. After the basic model recognizes the first publishing data containing information of the product A, it outputs the first-level product category prediction value, the second-level product category prediction value, and the third-level product category prediction value corresponding to product A based on the three fully connected layers. Since the basic model needs to output corresponding data for each level of product attribute categories, it can further improve the basic model's understanding of the hierarchical relationship among product attribute categories and improve the accuracy of the output classification prediction value. On this basis, the parameters of the basic model are reversely adjusted according to the output results of the basic model until the output results of the basic model can reach the preset accuracy.

Further, in an embodiment, identifying the initial product data based on the preset model and generating the second publishing information in step M3 includes the following steps M3.1 to M3.4.

Step M3.1, inputting the initial product data into the preset model.

Step M3.2, identifying the initial product data based on the preset model and outputting the target classification prediction value corresponding to the minimum category of product attributes.

Step M3.3, querying the database based on the target classification prediction value to determine the classification information corresponding to each level of product attribute category.

Step M3.4, generating the second publishing information based on the classification information and the target classification prediction value.

In an embodiment, in actual applications, since the deep model may have identification errors in the hierarchical relationship of product attribute categories, the e-commerce ERP system directly obtains the target classification prediction value corresponding to the smallest category of product attributes output by the deep model, and queries the database for product category information at other levels based on the target classification prediction value. This can avoid product publishing failures caused by errors in the hierarchical relationship between product category information at all levels, thereby improving the success rate of product publishing.

For example, assuming that product A has three levels of product attribute categories, the e-commerce ERP system obtains the third-level product category prediction value output by the deep model, and obtains the first-level product category information and the second-level product category information corresponding to product A by querying the database according to the third-level product category prediction value.

Further, in an embodiment, before step M5, the method further includes the following steps M7.1 to M7.3.

Step M7.1, in response to the second publishing instruction, generating a pop-up interactive interface based on the mandatory items on the publishing page of the e-commerce platform.

Step M7.2, obtaining product publishing data based on the pop-up interactive interface.

Step M7.3, generating first publishing information, second publishing information and third publishing information based on the product publishing data.

In an embodiment, in the existing e-commerce ERP system, multiple product publishing pages corresponding to each product platform/site are usually arranged and displayed, and users need to set product publishing information on multiple product publishing pages respectively. In this embodiment, multiple product publishing pages corresponding to multiple product platforms/sites are integrated into one product publishing page, and the setting items on the product publishing page are interactive in the form of pop-up windows, so that users can set the product publishing information corresponding to each product platform/site in a targeted manner through the pop-up windows of the setting items.

Further, based on the above embodiment, step M7.2 includes the following steps M7.21 and M7.22.

Step M7.21, in response to detecting that the mandatory item corresponding to the first publishing information is blank, marking the mandatory item based on the preset display effect.

Step M7.22, obtaining the product publishing data corresponding to the mandatory item based on the pop-up interactive interface, the product publishing data has a higher data usage priority than the initial product data.

In an embodiment, in actual applications, users select pre-set claim rules for publishing products on the interactive page of the e-commerce ERP system. If the claim rules do not contain some information, the e-commerce ERP system will generate the first publishing information based on the initial product data corresponding to the claim rules. The first publishing information fails to fully meet the mandatory items of the product publishing page. At this time, the e-commerce ERP system marks the blank mandatory items with specific effects, including highlighting, generating prompts, etc., to remind users to fill in the mandatory items in time. The user clicks on the mandatory item on the interactive page of the e-commerce ERP system, a pop-up window corresponding to the mandatory item is generated on the interactive page, and the user fills in the first publishing information through the pop-up window. In addition, when the mandatory item contains both the first publishing information generated by the e-commerce ERP system based on the claim rule and the first publishing information input by the user, the e-commerce ERP system identifies and gives priority to the information input by the user according to the data source identifier.

Further, in an embodiment, obtaining the initial product data in response to the first publishing instruction in step M2 includes the following steps M2.1 and M2.2.

Step M2.1, in response to the first publishing instruction, determining the target claim rule corresponding to the first publishing instruction in the database. The database stores multiple claim rules, and the multiple claim rules correspond to different initial product data respectively.

Step M2.2, obtaining the initial product data corresponding to the target claim rule.

In an embodiment, the e-commerce ERP system responds to the first publishing instruction triggered by the user, determines the target claim rule among multiple claim rules for product publishing, and generates the first publishing information based on the initial product data corresponding to the target claim rule. In this embodiment, the user can pre-set multiple claim rules for the same product, and the claim rules are set corresponding to different e-commerce platforms, sites, stores or time periods, respectively corresponding to different product names, product prices, logistics methods and other information, to meet the personalized needs of users when publishing products.

Further, in an embodiment, before step M5, the method further includes the following steps M5.1 to M5.3.

Step M5.1, determining the number of stores A1 and the product inventory B1 based on the first publishing information, comparing the number of stores A1 with the preset number of stores A2, and comparing the product inventory B1 with the preset inventory B2.

Step M5.2, in response to that the number of stores Alis greater than or equal to the preset number of stores A2, and the product inventory B1 is greater than or equal to the preset inventory B2, obtaining the target product traffic word with search ranking C1 is less than or equal to preset ranking C2 on each e-commerce platform according to the product category information.

Step M5.3, setting the product name of the first publishing information based on the target product traffic word.

In actual applications, sellers can increase product exposure and traffic by listing the same product in multiple stores and personalizing product names, thereby increasing product sales. In this embodiment, after the e-commerce ERP system generates the first publishing information based on the initial product information, it compares the number of stores A1 for the first publishing information with the preset number of stores A2, and compares the product inventory B1 with the preset inventory B2. The preset number of stores A2 and the preset inventory B2 are parameter standards pre-set by the user and used to measure whether the currently published product can be a key product.

If the number of stores A1 is greater than or equal to the preset number of stores A2, and the product inventory B1 is greater than or equal to the preset inventory B2, it means that the current product publishing involves many stores and the product inventory is also large. At this time, the e-commerce ERP system determines that the current product is a key product that the user focuses on promoting and selling. According to the product category information in the second publishing information, the relevant and relatively popular target product traffic words are obtained on the e-commerce platform, and the search ranking of the target product traffic words C1 is less than or equal to the preset ranking C2. For example, the relevant product traffic words with search rankings in the top three, top five or top ten are obtained as the target product traffic words, then the target product name is generated according to the target product traffic word, and the first publishing information is modified and set based on the target product name.

In this way, this embodiment regenerates the product name of the key product based on the popular product traffic words, which can ensure that the product name is associated with the current high-heat words, thereby increasing the exposure traffic of the product. In addition, since the preset number of stores A2 represents the promotion scope of the products published by the user, and the preset inventory B2 represents the user's sales forecast and inventory turnover efficiency for the current product. The e-commerce ERP system in this embodiment only generates product names for key products that have been screened by the preset number of stores A2 and preset inventory B2 standards. This avoids the excessive system pressure caused by having to regenerate product names for all products, thereby accurately increasing the exposure traffic of key products while reducing the system operation load as much as possible.

In other embodiments, the e-commerce ERP system sets and modifies other information related to product exposure, such as product display page data of the first publishing information, based on the popular product traffic words, to further increase the exposure traffic of key products. The information modification method is not specifically limited here.

The above is only some embodiment of the present application, and does not limit the scope of the present application. All equivalent transformations made by using the contents of specification and drawings of the present application under the inventive concept of the present application, or directly/indirectly applied in other related technical fields, are included in the scope of the present application.

What is claimed is:

1. A method for publishing products on multiple platforms, comprising:
determining, in response to a platform determination instruction, ports of e-commerce platforms corresponding to the platform determination instruction;
obtaining initial product data in response to a first publishing instruction, and generating first publishing information based on the initial product data, wherein the first publishing information comprises a publishing store, a product inventory, a product weight, and a logistics mode, and the first publishing information is mandatory information to be filled in when publishing products on each of the e-commerce platforms;
identifying the initial product data based on a preset model to generate second publishing information, wherein the second publishing information comprises product category information, the preset model comprises a plurality of fully connected layers corresponding to product attribute categories of the e-commerce platforms, the plurality of fully connected layers are respectively configured to output a plurality of classification prediction values corresponding to the product attribute categories, and the product category information is generated based on the classification prediction values;
detecting a blank mandatory item related to product attributes in a publishing page of each of the e-commerce platforms, and setting a preset sequence option of the blank mandatory item as third publishing information; and
sending the first publishing information, the second publishing information, and the third publishing information to the ports of the e-commerce platforms to publish a product corresponding to the initial product data on each of the e-commerce platforms.

2. The method of claim 1, further comprising:
obtaining historical publishing data corresponding to products of each of the e-commerce platforms; and
training a preset model corresponding to each of the e-commerce platforms based on the historical publishing data.

3. The method of claim 2, wherein training the preset model corresponding to each of the e-commerce platforms based on the historical publishing data comprises:
determining a data source identifier corresponding to the historical publishing data;
classifying the historical publishing data into first publishing data and second publishing data according to the data source identifier, wherein the first publishing data is historical publishing data that is not modified by a user, and the second publishing data is historical publishing data that is modified by a user;
training a preset model corresponding to each of the e-commerce platforms based on the first publishing data; and
verifying accuracy of the preset model in outputting the classification prediction values based on the second publishing data.

4. The method of claim 3, wherein training the preset model corresponding to each of the e-commerce platforms based on the first publishing data comprises:
inputting the first publishing data into a base model to enable the base model identify the first publishing data, and outputting a plurality of training classification prediction values corresponding to the product attribute categories of the e-commerce platforms based on the plurality of fully connected layers respectively; and
adjusting a parameter of the base model based on the plurality of training classification prediction values.

5. The method of claim 1, wherein identifying the initial product data based on the preset model to generate the second publishing information comprises:
inputting the initial product data into the preset model;
identifying the initial product data based on the preset model to output a target classification prediction value corresponding to a minimum product attribute category;
querying a database based on the target classification prediction value to determine classification information respectively corresponding to each level of product attribute categories; and
generating the second publishing information based on the classification information and the target classification prediction value.

6. The method of claim 1, wherein before sending the first publishing information, the second publishing information, and the third publishing information to the ports of the e-commerce platforms to publish the product corresponding to the initial product data on each of the e-commerce platforms, the method further comprises:
in response to a second publishing instruction, generating a popup interactive interface based on mandatory items of a publishing page of the e-commerce platform;
obtaining product publishing data based on the popup interactive interface; and
generating the first publishing information, the second publishing information and the third publishing information based on the product publishing data.

7. The method of claim 6, wherein obtaining the product publishing data based on the popup interactive interface comprises:
in response to detecting that a mandatory item corresponding to the first publishing information is blank, marking the mandatory item based on a preset display special effect; and
obtaining the product publishing data corresponding to the mandatory item based on the popup interactive interface, wherein the product publishing data is higher than the initial product data in data usage priority.

8. The method of claim 1, wherein obtaining the initial product data in response to the first publishing instruction comprises:
determining a target claim rule corresponding to the first publishing instruction in a database in response to the first publishing instruction, wherein a plurality of claim rules are stored in the database, and the plurality of claim rules correspond to different initial product data respectively; and
obtaining the initial product data corresponding to the target claim rule.

9. The method of claim 1, wherein before sending the first publishing information, the second publishing information, and the third publishing information to the ports of the e-commerce platforms to publish the product corresponding to the initial product data on each of the e-commerce platforms, the method further comprises:
determining a number of stores and a product inventory based on the first publishing information, comparing the number of stores with a preset number of stores, and comparing the product inventory with a preset inventory;
in response to that the number of stores is greater than or equal to the preset number of stores and the product inventory is greater than or equal to the preset inventory, obtaining a target product traffic word with a search ranking less than or equal to a preset ranking on the e-commerce platforms according to the product category information; and
setting a product name of the first publishing information based on the target product traffic word.

10. A system for publishing products on multiple platforms, wherein the system is configured to execute an operation instruction included in the method for publishing products on multiple platforms of claim 1.
